(19) United States
(12) Patent Application Publication
(10) Pub. No.: US 2013/0235286 A1
(43) Pub. Date: Sep. 12, 2013

(54) REAL-TIME AUTO-DIMMING SAFETY LENS DEVICE

(71) Applicant: PAI-FU HUNG, Tainan City (TW)

(72) Inventor: PAI-FU HUNG, Tainan City (TW)

(21) Appl. No.: 13/762,295

(22) Filed: Feb. 7, 2013

(30) Foreign Application Priority Data
Mar. 6, 2012 (TW) 101107547

(51) Int. Cl. G02C 7/10; G02F 1/13

(52) U.S. Cl. CPC G02C 7/101; G02F 1/1313
USPC 349/14; 250/214 AL

(57) ABSTRACT

A real-time auto-dimming safety lens device is adapted to assemble a dimmable lens, position various and fix a light sensor, controller and power supply, where the controller receives accurate visible-light illumination signals from a light sensor immediately and calculates the best transmittance or color of a dimmable lens, controls the transmittance or color of the environmental visible light penetrating the dimmable lens immediately and accurately so as to allow human's eyes to reach the farthest visible distance, be in the most comfortable state, and get the clearest environment scene. Therefore, a user can use the real-time auto-dimming safety lens device of the present invention to allow the user's eyes to reach the farthest visible distance, be in the most comfortable state, and get the clearest scene while the use locates in a particular environment (e.g. raining day, fogginess, snowfield).

### TECHNICAL FIELD OF THE INVENTION

The present invention generally relates to a real-time auto-dimming safety lens device, and more particularly to a system for controlling transmittance or color of a lens accurately, electronically and immediately.

### DESCRIPTION OF THE PRIOR ART

In conventional auto-dimming safety lens devices, color change is generated on a lens after environmental light illuminates the lens. But, because the speed of the color change is very slow, a user cannot change the transmittance or color accurately and immediately when the user locates in a rapidly changing environment (e.g. during driving or sport) with the result that the user's eyes cannot reach the farthest visible distance immediately and the most comfortable state, causing the user to be always in a very dangerous state.

However, general sun glasses have fixed color and transmittance. Causing a user to be unable to obtain the clearest environmental scene while the user is in a rapidly changing environment (e.g. during driving or sport); this is the great disadvantage.

In addition, market discoloration ski goggles changing to a fixed color and illumination cannot change color and illumination automatically, skiers cannot have the clearest scene any time.

In addition, welding mask lens sets aims in the protection of users' eyes currently rather than the obtainment of the best scene.

Conventional lenses with changeable transmittance all aim in the protection of eyes, but, they always cannot satisfy users' safety consideration under a particular environment, for example, a driver's sight only limited in several meters while driving in heavily rainy day. Currently, there are not glasses made by taking safety into main consideration to match users' requirements; users' sight is only limited in several meters while drivers drive cars in a fog zone, but no glasses are made by taking safety into main consideration currently; users cannot have the clearest scene immediately while driving car into a basement or tunnel, causing the drivers to be in a very dangerous state, but no glasses are made by taking safety into consideration to conquer such kind of dangerous cause to conform to users' requirements; because the current ski goggles are all stressed on the protection of eyes from the light reflection by snow rather than the obtainment of the clearest scene, a skier's eyes cannot reach the farthest visible distance and get the clearest view in a rapidly changing environment during skiing.

### SUMMARY OF THE INVENTION

To improve the disadvantages mentioned above, the present invention proposes a real-time auto-dimming safety lens device, a controller thereof receives accurate visible-light illumination signals from a light sensor immediately and calculates the best transmittance or color of a dimmable lens, controls the transmittance or color of the environmental visible light penetrating the dimmable lens immediately and accurately so as to allow human's eyes to reach the farthest visible distance, be in the most comfortable state, and get the clearest environment scene. Therefore, a user can use the real-time auto-dimming safety lens device of the present invention to allow the user's eyes to reach the farthest visible distance, be in the most comfortable state, and get the clearest scene while the use locates in a particular environment (e.g. raining day, fogginess, snowfield). Thereupon, a user can get the clearest scene, the farthest visible distance while either driving or exercising, and the user's eyes are comfortable and not easily tired any time.

a user uses this real-time auto-dimming safety lens device to adjust the illumination and color of environmental visible light entering the user's eyes immediately, rapidly, accurately and automatically when the user locates in an environmental light rapidly changing condition so as to allow human eyes to reach a farthest visible distance and be in a most comfortable state, and the user, thereby, can get the clearest environmental scene. Furthermore, a user uses a real-time auto-dimming safety lens device of the present invention to filter excessive environmental visible light immediately and accurately while locating under a strong light environment (e.g. during driving or doing sports), avoiding causing visible image blur to the user under the strong light, and allowing human's eyes to get the cleared scene immediately and be in the most comfortable state.

### BRIEF DESCRIPTION OF THE DRAWINGS

FIG. 1 is a block diagram of a system of a preferred embodiment according to the present invention;

FIG. 2 is a schematically perspective view of the first lens structure of a real-time auto-dimming safety lens device of the present invention;

FIG. 3 is a schematically perspective view of the second lens structure of a real-time auto-dimming safety lens device of the present invention;

FIG. 4 is a schematically perspective view of the third lens structure of a real-time auto-dimming safety lens device of the present invention;

FIG. 5 is a schematically perspective view of the fourth lens structure of a real-time auto-dimming safety lens device of the present invention;

FIG. 6 is a graph, showing a relationship between transmittance and bias voltage of a real-time auto-dimming safety lens device;

FIG. 7 is a schematic view of a preferred embodiment attached with glasses according to the present invention;

FIG. 8 is a schematic view of safety helmet of a preferred embodiment according to the present invention; and

FIG. 9 is a schematic view of ski glasses of a preferred embodiment according to the present invention.

### DETAILED DESCRIPTION OF THE PREFERRED EMBODIMENTS

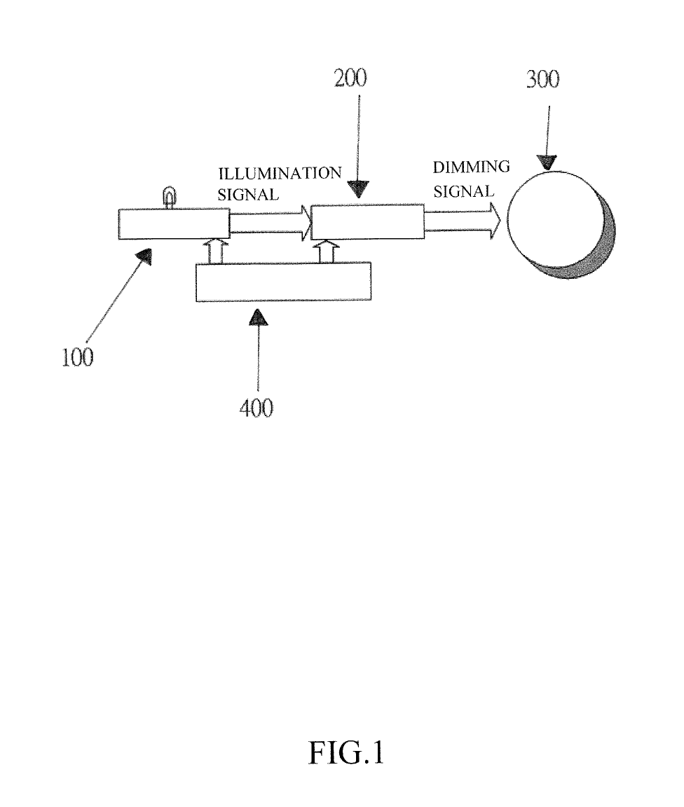

Referring to FIGS. 1 to 5, FIG. 1 is a block diagram, illustrating a system of a preferred embodiment according to the present invention. A real-time auto-dimming safety lens device, at least including one or more than one lens 300, an assembling frame, one or more than one light sensor 100, one or more than one controller 200 and one or more than one electric power supply, where the lenses may be overlaid or not overlaid, they hold a function of adjusting transmittance and color of light from a visible light source penetrating the lens immediately and accurately.

The assembling frame is used to assemble lenses thereon, allowing various parts to be positioned, and components mounted on it to be fixed.

The light sensor 100 is used to detect the illumination of environmental visible light immediately and accurately.

The controller 200 receives the accurate illumination signals of environmental visible light from the sensors 100 and controls the illumination or color of the environmental visible light penetrating the lens immediately and accurately.

The electric power supplies 400 provides stable electric power needed for the sensors 100 or controllers 200 through a voltage regulator circuit, and a stable reference voltage needed for the controllers 200 to control accurately the accurate illumination or color signals of environmental visible light penetrating the lenses.

In the embodiment, the controller 200 of a device for the immediate and automatic light adjusting of a safety lens receives immediately the accurate illumination signals of environmental visible light from the light sensors 100 and calculates the best transmittance or color, controlling immediately and accurately the illumination or color of environmental visible light penetrating the lenses 300, thereby allowing human's eyes to reach the farthest visible distance and be in the most comfortable state in the meantime. Thereupon, a user can get the clearest environmental scene any time.

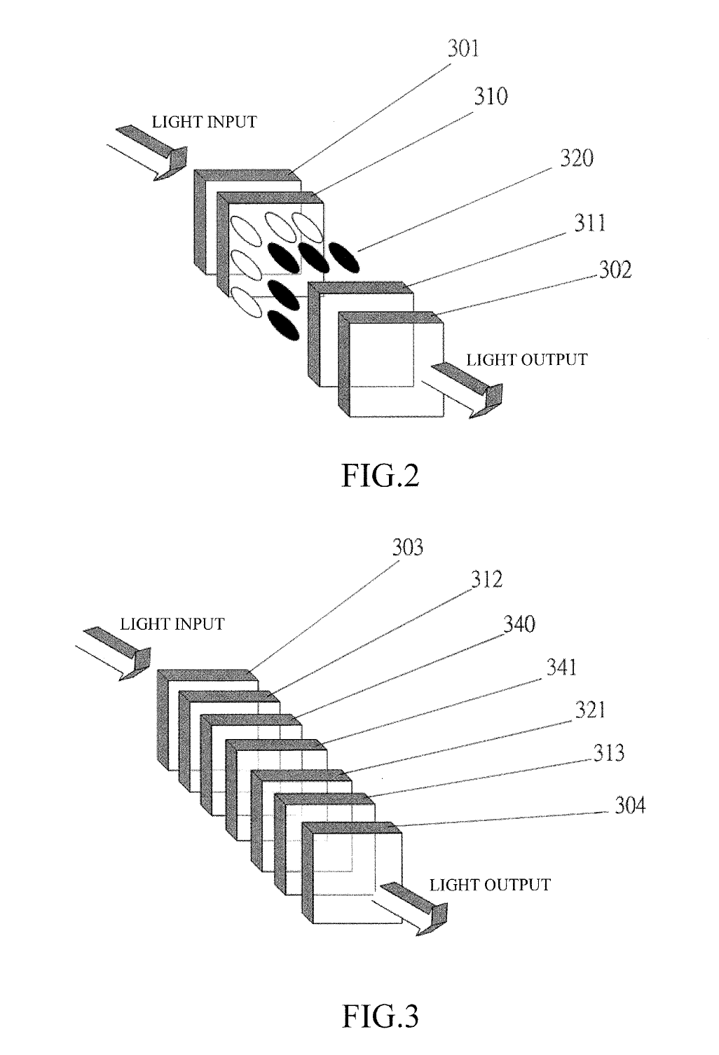

Referring to FIG. 2, illustrating a lens of a preferred embodiment, capable of adjusting the illumination or color of environmental visible light penetrating the lens, the lens at least includes one or more than one Liquid Crystals with Negative Dielectric Anisotropy layer 320 mixed with dye, in which Liquid Crystals with Negative Dielectric Anisotropy drives the rotation of the dye so as to cause the dye to absorb the illumination or color of environmental visible light, one or more than one upper light transmissive layer 302, one or more than one lower light transmissive layer 301, one or more than one upper electrode 311 and one or more than one lower electrode 310.

In the Liquid Crystals with Negative Dielectric Anisotropy layer 320 mixed with dye, the Liquid Crystals with Negative Dielectric Anisotropy drives the dye to rotate to absorb the illumination or color of environmental visible light.

The upper light transmissive layer 302 is a Liquid Crystals with Negative Dielectric Anisotropy coating layer after environmental visible light penetrates Liquid Crystals with Negative Dielectric Anisotropy.

The lower light transmissive layer 301 is a Liquid Crystals with Negative Dielectric Anisotropy coating layer before environmental visible light enters Liquid Crystals with Negative Dielectric Anisotropy.

The upper electrode 311 provides a reference voltage needed for the Liquid Crystals with Negative Dielectric Anisotropy to rotate the visible light.

The lower electrode 310 provides a bias voltage needed for the Liquid Crystals with Negative Dielectric Anisotropy to rotate the visible light.

Referring to FIG. 3, illustrating a lens of another preferred embodiment, capable of adjusting the illumination or color of environmental visible light penetrating the lens, the lens is another structure and at least includes one or more than one electrochromic film layer 321, one or more than one upper light transmissive layer 304, one or more than one lower light transmissive layer 303, one or more than one upper electrode layer 313, one or more than one lower electrode layer 312, one or more than one ion storage layer 340, and one and more than one ion conducting layer 341.

The electrochromic film layer 321 absorbs excess illumination or color of environmental visible light through the color change of ions.

The upper light transmissive layer 304 is the last layer of lens coating high light-transmission at a position that environmental visible light leaves the lens.

The lower light transmissive layer 303 is the first layer of lens coating high light-transmission at a position that environmental visible light enters the lens.

The upper electrode layer 313 provides a bias voltage needed for the electrochromic film layer.

The lower electrode layer 312 provides a bias voltage needed for the electrochromic film layer.

The ion storage layer 340 has an ion storing function and provides ions needed for absorbing the illumination or color of environmental visible light.

The ion conducting layer 341 conducts ions and blocks electrons so that the ions can be moved between the electrochromic layer 321 and ion storage layer 340.

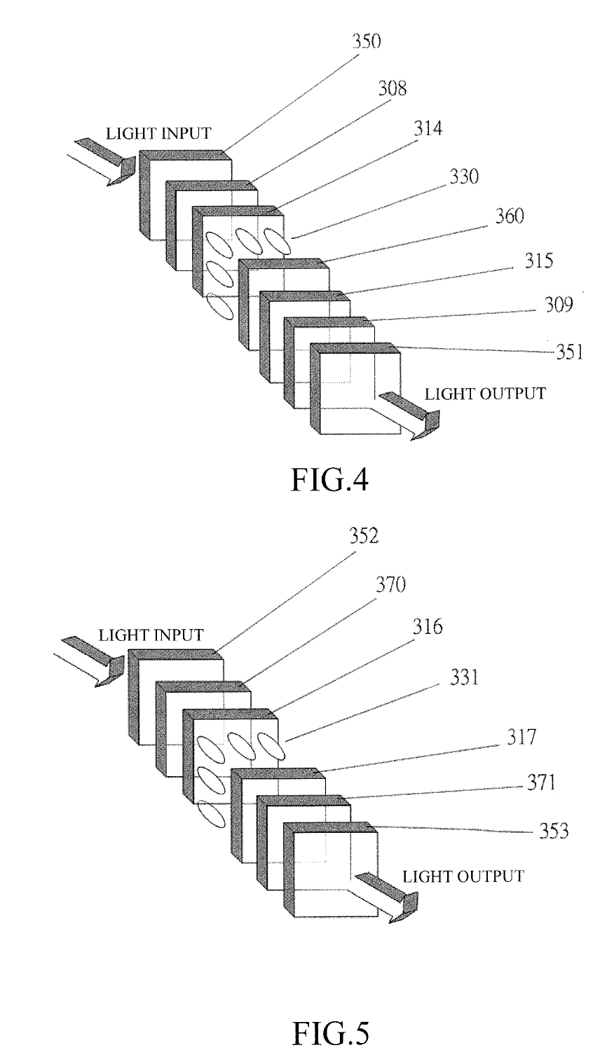

Referring to FIG. 4, illustrating a lens of yet another embodiment according to the present invention, capable of adjusting the illumination or color of environmental visible light penetrating the lens, the lens has another structure and at least includes one or more than one upper light transmissive layer 309, one or more than one lower light transmission layer 308, one or more than one upper electrode layer 315, one and more than one lower electrode layer 314, one or more than one lower polarizing layer 350, one or more than one upper polarizing layer 351, one or more than one Liquid Crystals with Negative Dielectric Anisotropy layer 330, and one or more than one upper filter layer 360.

The upper light transmissive layer 309 is a Liquid Crystals with Negative Dielectric Anisotropy coating layer after environmental visible light penetrates Liquid Crystals with Negative Dielectric Anisotropy.

The lower light transmissive layer 308 is a Liquid Crystals with Negative Dielectric Anisotropy coating layer before environmental visible light enters Liquid Crystals with Negative Dielectric Anisotropy.

The upper electrode layer 315 provides a reference voltage needed for the Liquid Crystals with Negative Dielectric Anisotropy to rotate the visible light.

The lower electrode layer 314 provides a bias voltage needed for the Liquid Crystals with Negative Dielectric Anisotropy to rotate the visible light.

The lower polarizing layer 350 polarizes environmental visible light.

The upper polarizing layer 351 polarizes the environmental visible light after being rotated by the Liquid Crystals with Negative Dielectric Anisotropy.

In the Liquid Crystals with Negative Dielectric Anisotropy layer 330, the Liquid Crystals with Negative Dielectric Anisotropy rotates the environmental visible light penetrating the lower light transmissive layer.

The upper filter layer 360 absorbs the color of excess environmental visible light after being rotated by the Liquid Crystals with Negative Dielectric Anisotropy.

Referring to FIG. 5, illustrating a lens of still another embodiment according to the present invention, capable of adjusting the illumination or color of environmental visible light penetrating the lens, the lens has another structure and at least includes one or more than one upper light transmissive layer 371, one or more than one lower light transmissive layer 370, one or more than one upper electrode layer 317, one and more than one lower electrode layer 316, one or more than one lower polarizing layer 352, one or more than one upper polarizing layer 353, and one or more than one Liquid Crystals with Negative Dielectric Anisotropy layer 331.

The upper light transmissive layer 371 is a Liquid Crystals with Negative Dielectric Anisotropy coating layer after environmental visible light penetrates Liquid Crystals with Negative Dielectric Anisotropy.

The lower light transmissive layer 370 is a Liquid Crystals with Negative Dielectric Anisotropy coating layer before environmental visible light enters Liquid Crystals with Negative Dielectric Anisotropy.

The upper electrode layer 317 provides a reference voltage needed for the Liquid Crystals with Negative Dielectric Anisotropy to rotate the visible light.

The lower electrode layer 316 provides a bias voltage needed for the Liquid Crystals with Negative Dielectric Anisotropy to rotate the visible light.

The lower polarizing layer 352 polarizes environmental visible light.

The upper polarizing layer 353 polarizes the environmental visible light after being rotated by Liquid Crystals with Negative Dielectric Anisotropy.

In the Liquid Crystals with Negative Dielectric Anisotropy layer 331, the Liquid Crystals with Negative Dielectric Anisotropy rotates the environmental visible light penetrating the lower light transmissive layer.

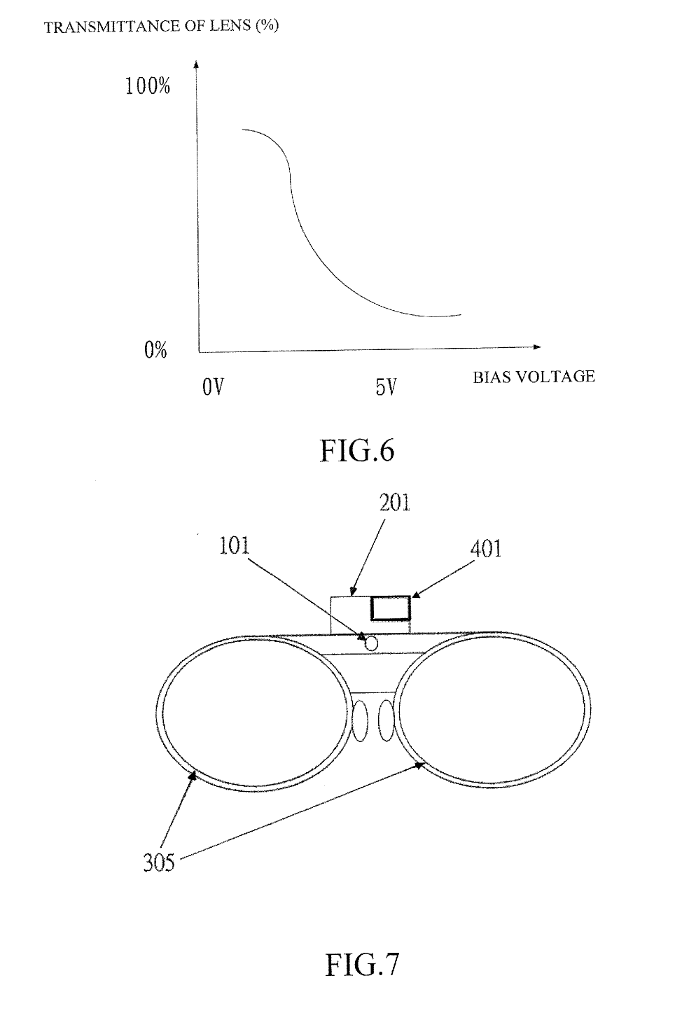

FIG. 6 is a graph showing the transmittance of the lens of a real-time auto-dimming safety lens device in FIG. 2 against the bias voltage thereof, where economy in electricity of the lens is mulled over. Referring to FIG. 6, the transmittance of the lens is higher when the dimming signal is a low bias voltage; the transmittance of the lens is lower when the dimming signal is a high bias voltage; the device is in the most electricity saving mode when it is received in an opaque storage case, because the real-time auto-dimming safety lens device need not output any dimming signal. In addition, the device has no dimming signal to control the dimmable lens 300 when the device is out of electricity or malfunctioned, the dimmable lens 300 is at a highest transmittance state in this situation, and a user can still use it and no safety issue needs to be concerned.

Referring to FIG. 7, which is a schematic view showing a real-time auto-dimming safety lens device attached with real-time glasses, a glasses frame of the attached glasses of the real-time auto-dimming safety lens device is mounted with two sheets of lens 305, which can adjust accurately the illumination or color of the environmental visible light penetrating the lenses.

An assembling frame is used for assembling lenses and positioning various parts and fixing components mounted on it.

A light sensor 101 is used to detect immediately the accurate illumination of environment visible light.

A controller 201 is used to receive immediately the illumination signals of the accurate environmental visible light from the light sensor and control immediately and accurately the illumination or color of the environmental visible light penetrating the lenses.

An electric power supplier 401 provides stable electric power needed for the sensors 101 or controllers 201 through a voltage regulator circuit, and a stable reference voltage needed for the controllers 201 to control accurately the accurate illumination or color signals of environmental visible light penetrating the lenses.

In the embodiment, the controller 201 of a real-time auto-dimming safety lens device attached with glasses receives immediately the accurate illumination signals of the environmental visible light source from the light sensors 101 and calculates the best transmittance or color, controlling immediately and accurately the illumination or color of the environmental visible light penetrating the lenses 300, thereby allowing human's eyes to reach the farthest visible distance and be in the most comfortable state in the meantime. Thereupon, a user can get the clearest environmental scene any time.

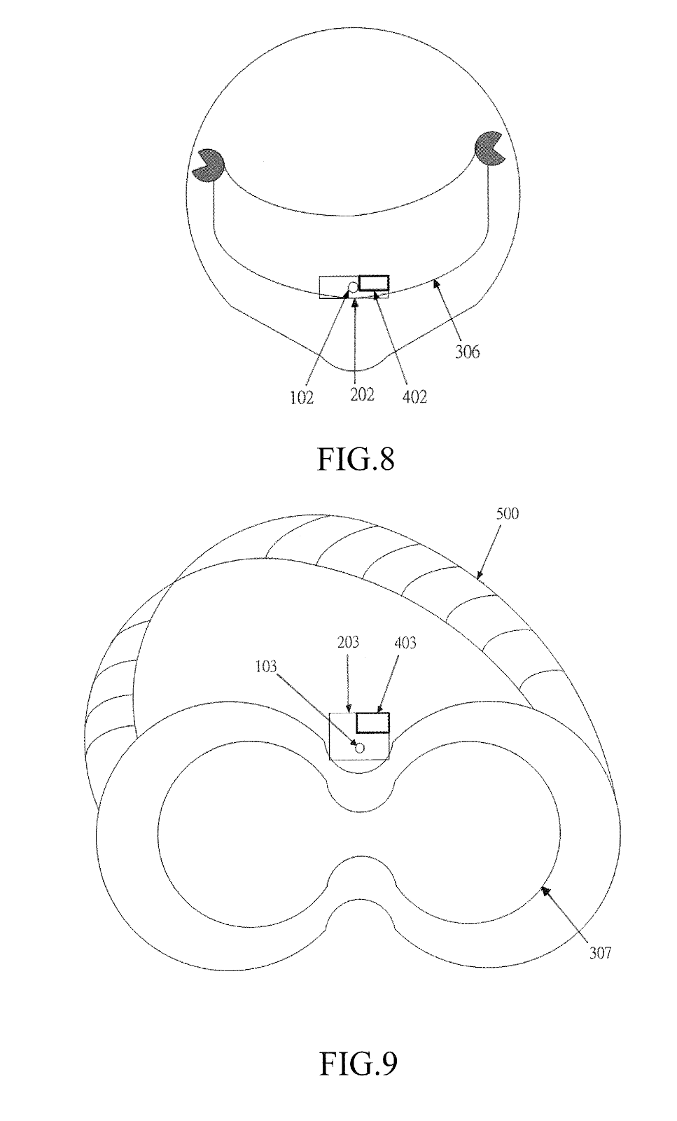

Referring to FIG. 8, which is a schematic view showing a real-time auto-dimming safety lens device for a safety helmet, a glasses frame of the safety helmet of the real-time auto-dimming safety lens device is mounted with a lens 306, which can adjust accurately the illumination or color of the environmental visible light penetrating the lenses.

An assembling frame is used for assembling lenses and positioning various parts and fixing components mounted on it.

A light sensor 102 is used to detect immediately the accurate illumination of environment visible light.

A controller 202 is used to receive immediately the illumination signals of the accurate environmental visible light from the light sensor and control immediately and accurately the illumination or color of the environmental visible light penetrating the lens.

An electric power supplier 402 provides stable electric power needed for the light sensor and controller through a voltage regulator circuit, and a stable reference voltage needed for the controller 202 to control accurately the accurate illumination or color signals of environmental visible light penetrating the lens 306.

In the embodiment, the controller 201 of a real-time auto-dimming safety lens device of a safety helmet receives immediately the accurate illumination signals of the environmental visible light source from the light sensors 101 and calculates the best transmittance or color, controlling immediately and accurately the illumination or color of the environmental visible light penetrating the lenses 300, thereby allowing human's eyes to reach the farthest visible distance and be in the most comfortable state in the meantime. Thereupon, a user can get the clearest environmental scene any time.

Referring to FIG. 9, which is a schematic view showing a real-time auto-dimming safety lens device for ski goggles, a glasses frame of the ski goggles of the real-time auto-dimming safety lens device is mounted with one or two lenses 307, which can adjust accurately the illumination or color of the environmental visible light penetrating the lenses.

An assembling frame is used for assembling lenses, positioning various parts and fixing components mounted on it.

A light sensor 103 is used to detect immediately the accurate illumination of environment visible light.

A controller 203 is used to receive immediately the illumination signals of the accurate environmental visible light from the light sensor and control immediately and accurately the illumination or color of the environmental visible light penetrating the lens.

An electric power supplier 403 provides stable electric power needed for the light sensor 103 and controller 203 through a voltage regulator circuit, and a stable reference voltage needed for the controller 203 to control accurately the accurate illumination or color signals of environmental visible light penetrating the lens 307.

In the embodiment, the controller 203 of a real-time auto-dimming safety lens device of ski goggles receives immediately the accurate illumination signals of the environmental visible light from the light sensors 103 and calculates the best transmittance or color, controlling immediately and accurately the illumination or color of the environmental visible light penetrating the lenses 307, thereby allowing human's eyes to reach the farthest visible distance and be in the most comfortable state in the meantime. Thereupon, a user can get the clearest environmental scene any time.

I claim:

1. A real-time auto-dimming safety lens device, at least comprising:
one or more than one lens, overlaid or not overlaid, and having a function of adjusting transmittance and color of environmental visible light penetrating said lens immediately and accurately;
one or more than one assembling frame, adapted to assemble said lenses thereon, position various parts and fix components mounted thereon;
one or more than one light sensor, adapted to detect real-time and accurate illumination of environmental visible light, and transmit said illumination signals of environmental visible light to a controller;
one or more than one said controller, receiving said accurate and real-time illumination signals of environmental visible light from said sensors and controlling said illumination or color of environmental visible light penetrating the lenses immediately and accurately; and
one or more than one electric power supplier, providing stable electric power needed for said sensors or controllers, and a stable reference voltage needed for said controllers to control accurately said accurate illumination or color signals of environmental visible light penetrating said lenses.
wherein, said controller of said real-time auto-dimming safety lens device receives immediately said accurate illumination signals of environmental visible light from said light sensors and calculates the best transmittance or color, controlling accurately said illumination or color of said environmental visible light penetrating said lenses.

2. The device according to claim 1, wherein said lens, at least comprising:
one or more than one Liquid Crystals with Negative Dielectric Anisotropy layer, mixed with dye,
Liquid Crystals with Negative Dielectric Anisotropy driving said dye to rotate, said rotated dye absorbing said illumination or color of said environmental visible light;
one or more than one upper light transmissive layer, being a Liquid Crystals with Negative Dielectric Anisotropy coating layer after said environmental visible light penetrates said Liquid Crystals with Negative Dielectric Anisotropy layer;
one or more than one lower light transmissive layer, being a Liquid Crystals with Negative Dielectric Anisotropy coating layer before said environmental visible light penetrates said Liquid Crystals with Negative Dielectric Anisotropy layer;
one or more than one upper electrode, providing a reference voltage needed for said Liquid Crystals with Negative Dielectric Anisotropy to rotate said visible light; and
one or more than one lower electrode, providing a bias voltage needed for said Liquid Crystals with Negative Dielectric Anisotropy to rotate said visible light.

3. The device according to claim 1, wherein said lens, being another structure and at least comprising:
one and more than one electrochromic film layer, absorbing excess illumination or color of said environmental visible light through color change of ions;
one or more than one upper light transmissive layer, being the last lens coating high light-transmission layer at a position that said environmental visible light leaves said lens;
one and more than one lower light transmissive layer, being the first lens coating high light-transmission layer at a position that said environmental visible light enters said lens;
one and more than one upper electrode layer, providing a bias voltage needed for said electrochromic film layer;
one and more than one lower electrode layer, providing a bias voltage needed for said electrochromic film layer.
one or more than one ion storage layer, having an ion storing function and providing ions needed for absorbing said illumination or color of environmental visible light; and
one and more than one ion conducting layer, conducting ions and blocking electrons, the ions being movable between the electrochromic layer and ion storage layer.

4. The device according to claim 1, wherein said lens, being another structure and at least comprising:
one and more than one upper light transmissive layer, being a Liquid. Crystals with Negative Dielectric Anisotropy coating layer after environmental visible light penetrates a Liquid Crystals with Negative Dielectric Anisotropy layer;
one and more than one lower light transmissive layer, being a Liquid Crystals with Negative Dielectric Anisotropy coating layer before environmental visible light penetrates said Liquid Crystals with Negative Dielectric Anisotropy layer;
one and more than one upper electrode layer, providing a reference voltage needed for Liquid Crystals with Negative Dielectric Anisotropy to rotate said visible light;
one or more than one lower electrode layer, providing a bias voltage needed for said Liquid Crystals with Negative Dielectric Anisotropy to rotate said visible light;
one or more than one lower polarizing layer, polarizing environmental visible light;
one or more than one upper polarizing layer, polarizing said environmental visible light after being rotated by said Liquid Crystals with Negative Dielectric Anisotropy;
one or more than one said Liquid Crystals with Negative Dielectric Anisotropy layer, said Liquid Crystals with Negative Dielectric Anisotropy rotating said environmental visible light penetrating said lower light transmissive layer; and
one or more than one upper filter layer, absorbing color of excess environmental visible light after being rotated by said Liquid Crystals with Negative Dielectric Anisotropy.

5. The device according to claim 1, wherein said lens, being another structure and at least comprising:
one and more than one upper light transmissive layer, being a Liquid Crystals with Negative Dielectric Anisotropy coating layer after environmental visible light penetrates a Liquid Crystals with Negative Dielectric Anisotropy layer;
one or more than one lower light transmissive layer, being a Liquid Crystals with Negative Dielectric Anisotropy coating layer before environmental visible light enters said Liquid Crystals with Negative Dielectric Anisotropy layer;
one or more than one upper electrode layer, providing a reference voltage needed for Liquid Crystals with Negative Dielectric Anisotropy to rotate said visible light;
one or more than one lower electrode layer, providing a bias voltage needed for said. Liquid Crystals with Negative Dielectric Anisotropy to rotate said visible light;
one or more than one lower polarizing layer, polarizing environmental visible light;
one or more than one upper polarizing layer, polarizing said environmental visible light after being rotated by said Liquid Crystals with Negative Dielectric Anisotropy; and
one or more than one said Liquid Crystals with Negative Dielectric Anisotropy layer, said Liquid Crystals with Negative Dielectric Anisotropy rotating said environmental visible light penetrating said lower light transmissive layer.
